(19) United States
(12) Patent Application Publication
(10) Pub. No.: US 2018/0139019 A1
(43) Pub. Date: May 17, 2018

(54) MULTI-CARRIER COMPRESSED SENSING MULTI-USER SYSTEM

(71) Applicant: UNIVERSITAT BREMEN, Bremen (DE)

(72) Inventors: Fabian MONSEES, Bremen (DE); Matthias WOLTERING, Bremen (DE); Armin DEKORSY, Bremen (DE); Carsten BOCKELMANN, Achim (DE)

(21) Appl. No.: 15/571,905

(22) PCT Filed: May 4, 2016
(86) PCT No.: PCT/EP2016/060064

§ 371 Date: Nov. 6, 2017

(30) Foreign Application Priority Data
May 6, 2015 (DE) 10 2015 208 344.6
May 6, 2015 (LU) 92709

(51) Int. Cl. H04L 5/00; H04L 27/26; H04L 29/06

(52) U.S. Cl. CPC H04L 5/0037; H04L 69/04; H04L 27/2601

(57) ABSTRACT

The invention concerns a multi-carrier compressed sensing multi-user system, wherein the system can provide connections between a base station and a plurality of terminal devices, wherein multiple terminal devices may access the same transmission medium at the same time, wherein the system uses a multi-carrier modulation with a set N of carriers, wherein a terminal device uses at least one subset M₁, M₂, . . . of carriers of the set N of carriers in each case, where M₁,M₂<N, and wherein a first terminal device uses a first subset M₁ of carriers and a second terminal device uses a second subset M₂ of carriers, wherein at least one carrier of the first subset M₁ is also part of the second subset M₂, wherein furthermore the base station detects a transmission of the terminal device from the plurality of the received set N of carriers by means of compressed sensing multi-user detection.

The invention concerns a multi-carrier compressed sensing multi-user system.

### BACKGROUND OF THE INVENTION

At the present time, there is a massive increase in the demand for communication in general and data communication in particular, while the quantity of information being transmitted is rather small.

One sample representative of this type of communication is so-called machine type communication, which finds an embodiment in machine-to-machine or M2M communication. This is often also described as the Internet of things.

It is characteristic of this that data is sent only sporadically from a plurality of devices.

Hence, the massive accessing of the transmission medium—the physical layer PHY in the ISO/OSI model—by a plurality of devices constitutes a serious problem.

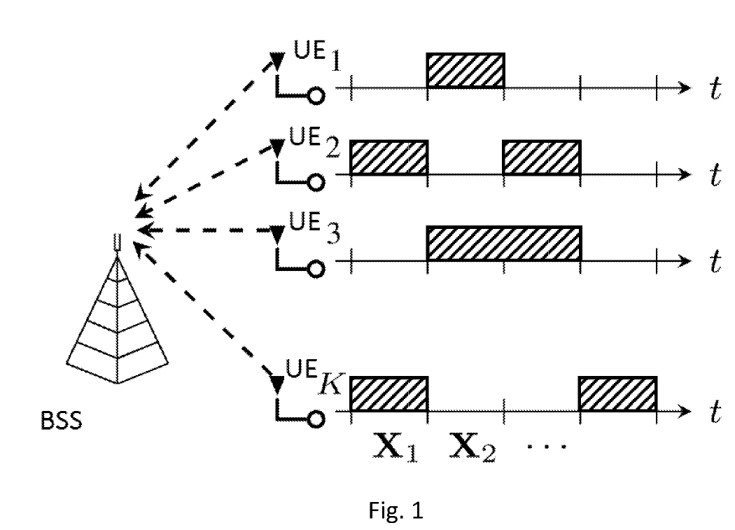

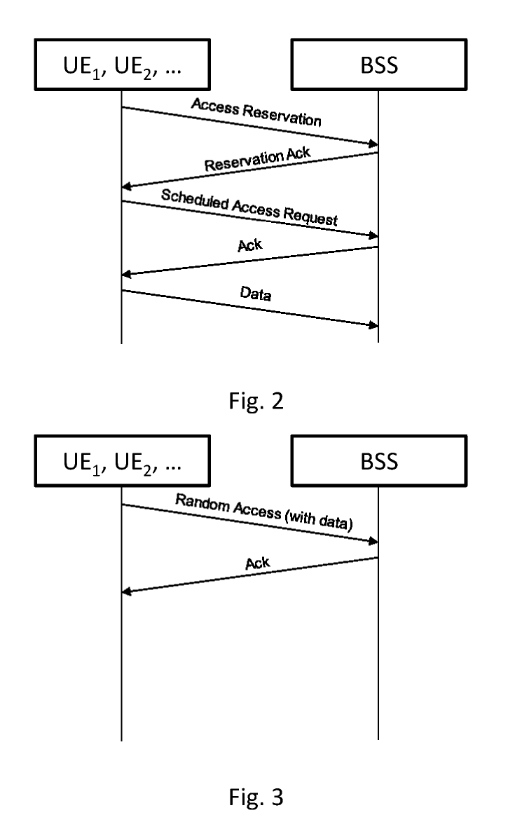

This shall be illustrated more closely by means of FIGS. 1 and 2.

FIG. 1 shows a typical scenario in which a plurality of terminal devices UE₁, UE₂, UE₃, . . . UE_{K} communicate with a central station BSS via a not otherwise specified transmission medium. That is, the system is a multi-user system.

The times t at which a terminal device UE₁, UE₂, UE₃, . . . UE_{K} communicates with the central station BSS are shown in the respective diagrams at the right of the respective terminal device by a slanting hatched region.

It would be desirable in principle for a number of terminal devices to be able to communicate in parallel with the central station BSS, as shown in FIG. 1. That is, a number of terminal devices UE₁, UE₂, . . . could access the same transmission medium at the same time.

Using the example of a wireless communication such as might take place in a wireless mobile radio communication system of the 3rd Generation Partnership Project (3GPP), the typical process according to the prior art shall now be demonstrated.

As shown in FIG. 2, a terminal device UE₁, UE₂, . . . would first secure access to a data transmission medium.

In a wireless communication system this can be done, for example, by an access reservation through a control channel. Depending on the access scheme used (such as orderly TDMA), moreover, a scheduled access request can be used. Typically, the secure obtaining of an access reservation is signaled by a reservation Ack or the granting of an access request is signaled by an Ack to the respective terminal device.

Only after the data transmission medium has been allocated for the transmission of data from the terminal device to the central station BSS can the data then be actually sent.

In such a scenario, the respective available bandwidth B is often available to only one terminal device.

It is immediately evident that, in the given context—whether wireless or wired—the expense for the payload transmission is substantial and in case of doubt even the data quantity sent for the allocation is greater than or even much greater than the payload quantity.

Starting from this situation, the problem which the invention proposes to solve is to provide a system and corresponding method to enable an improved usage of the available bandwidth.

The problem is solved by a system according to claim 1 and a method according to claims 4 and 7. Further advantageous embodiments are the subject matter in particular of the dependent claims.

The invention shall now be explained more closely with reference to the figures.

FIG. 1 shows an example situation of a communication systems in which the invention may be used,

FIG. 2 shows an example communication process in systems of the prior art,

FIG. 3 shows an example communication process in systems according to the invention,

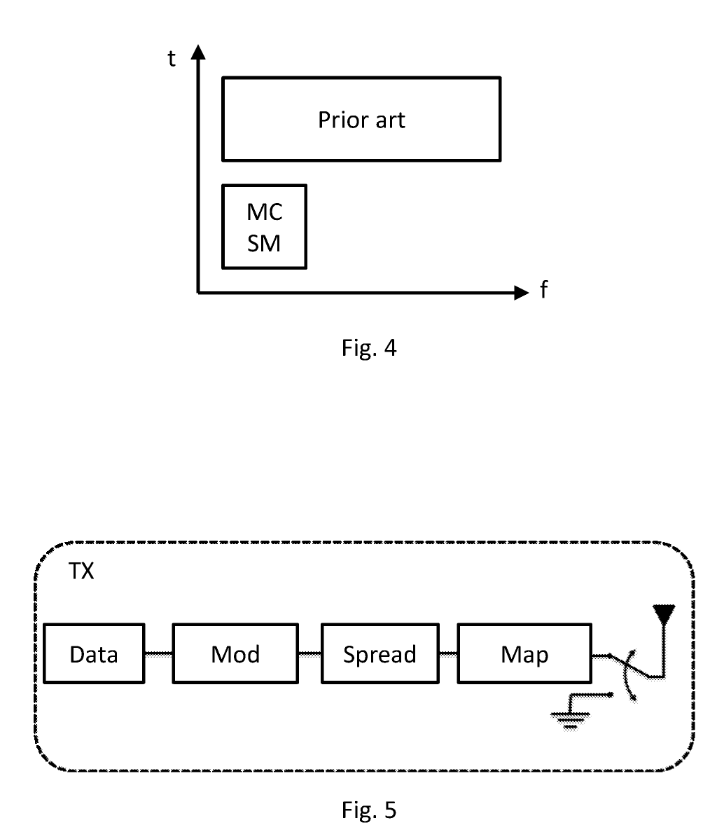

FIG. 4 shows an example comparison of the resource consumption in a system according to the invention as opposed to systems of the prior art,

FIG. 5 shows an example schematic layout of steps according to embodiments of the invention in regard to terminal devices according to the invention,

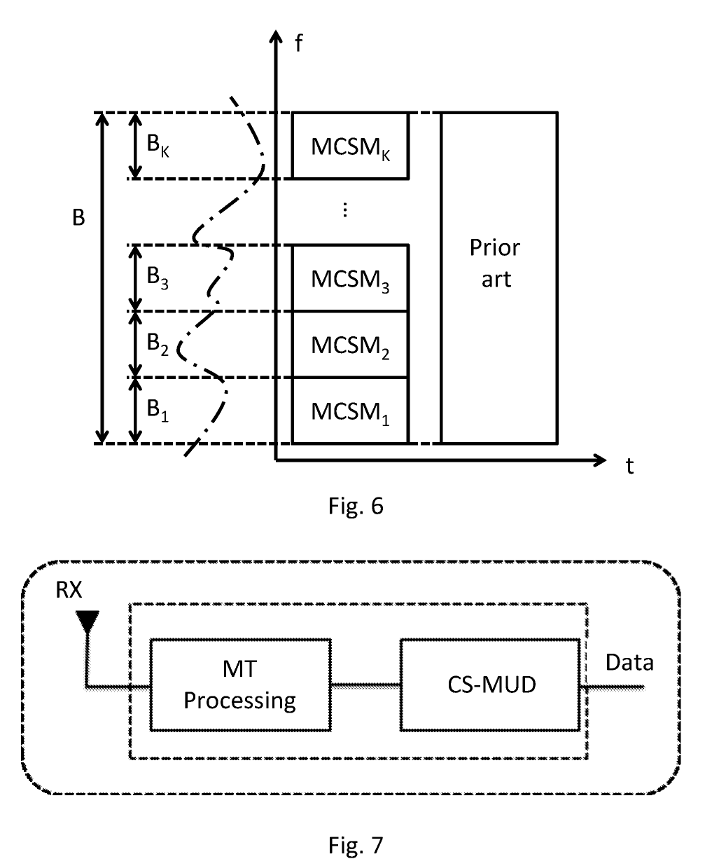

FIG. 6 shows an example comparison of the resource consumption in a system according to the invention as opposed to systems of the prior art, and

FIG. 7 shows an example schematic layout of steps according to embodiments of the invention in regard to base stations according to the invention.

Although the invention is described below in regard to a wireless communication system, the idea of the invention is also equally applicable in wired communication systems. Accordingly, the following description is not limited to wireless communication systems.

Moreover, although the invention is described below in regard to communication systems of the 3^{rd} Generation Partnership Project (3GPP), the invention is not limited to these communication systems. In particular, the invention is applicable to all multi-carrier transmission systems with a plurality of users.

Without limiting the generality of the invention, this is applicable to different kinds of access. That is, so far as the following description refers to an access type, this is always to be understood as merely one example.

Quite generally, the invention pertains to the physical access to the transmission medium.

The invention shall now be explained more closely in regard to FIG. 4.

In a multi-carrier compressed sensing multi-user system according to the invention, connections are enabled between a base station BSS and a plurality of terminal devices UE₁, UE₂, . . . . The term base station BSS as well as the term terminal device UE₁, UE₂, . . . are heavily borrowed from the typical usage in mobile radio.

However, the invention is not limited to this. For example, a transmission by multi-carrier also occurs in other wired systems, such as DSL or Powerline, and also in other wireless systems, such as WLan (e.g. IEEE 802.11 a/g/n), WiMax (e.g. IEEE 802.16.2-2004) or Bluetooth. Accordingly, the base station BSS is comparable in regard to the communication of a central station, as described at the outset.

In a multi-carrier system, the data being sent is transmitted in the frequency domain, instead of the time domain.

Within the system, several terminal devices UE₁, UE₂, . . . may access the same transmission medium at the same time. Furthermore, several terminal devices UE₁, UE₂, . . . may use the same physical resource (time and frequency).

A typical process of the accessing of a terminal device UE₁ is shown in FIG. 3. The terminal device UE₁ sends its data directly to the base station BSS, i.e., without prior allocation of the medium. If this data is received successfully, depending on the type of connection protocol an acknowledgement Ack may be sent back by the base station BSS to the terminal device UE₁ (correction-oriented, confirmed), or such a message may be omitted (no connection, unconfirmed). Such an access can also be called direct random access.

For example, if general non-security-relevant data on the state of a terminal device is sent, no message need occur.

Depending on the design, the terminal device UE₁ is able, for example during a connection-oriented establishment process, to re-send the message after waiting to see if an acknowledgement Ack was received.

The system itself uses a multi-carrier modulation (MCM) with a set N of carriers. The nature and type of modulation of these carriers (e.g., discrete multitone, COFDM, etc.) is not necessary for an understanding of the application.

The terminal devices UE₁; UE₂; . . . each use at least one subset M₁, M₂, . . . of carriers of the set N of carriers. That is, terminal device UE₁ uses subset M₁, terminal device UE₂ uses subset M₂, and so on. The respective subsets always constitute only part of the total set N of carriers, that is, M₁, M₂<N. Subsets may have either the same numbers (M₁=M₂) or also different numbers (M₁< >M₂) of carriers.

In the following it shall be assumed that a first terminal device UE₁ uses a first subset M₁ of carriers and a second terminal device UE₂ uses a second subset M₂ of carriers, wherein at least one carrier of the first subset M₁ is also part of the second subset M₂.

In previous approaches, the entire bandwidth of N carriers was always used as the medium access. That is, in a CDMA system, each terminal device UE₁; UE₂; . . . would be allocated the full bandwidth and the data would be distributed among the frequency domains. This entails a substantial expense considering the small quantity of data, since the bandwidth resource is taken up by a single terminal device, while the bandwidth is not in fact needed. Since the full bandwidth is utilized, so too must be the frequency response of the physical channel, in order to determine the transfer function at the receiver. This is a complex problem requiring a great deal of effort.

As is evident from FIG. 4, a MCSM system corresponding to the bandwidth of a terminal device UE₁; UE₂; . . . requires a significantly smaller bandwidth than a system in the prior art because of the smaller number of carriers M₁, M₂, . . . .

In the system now proposed, one can advantageously utilize the attribute of the transmitter/transmitters TX, i.e., the terminal devices UE₁; UE₂; . . . , namely, that the signals are perceived as being sparsely occupied.

This attribute of the signals—that of being “sparsely occupied”—is due to a low activity of the terminal devices UE₁; UE₂; . . . , e.g., of sensors, so that at a particular point in time only a small number of the totality of terminal devices UE₁; UE₂; . . . is active, as can be seen e.g. in FIG. 1.

Now the base station BSS can detect a transmission of the terminal device UE₁; UE₂; . . . from the plurality of the received set N of carriers by means of compressed sensing multi-user detection (CS-MUD).

Furthermore, it should be noted that the number of carriers of the subsets M₁, M2, . . . need not necessarily be identical. In making the choice of the number of carriers, considerations of the data volume being transmitted, the data rate, the transmission security, etc., and requirements of higher layers in the ISO/OSI model, etc., may be taken into account. Furthermore, the principle of compressed sensing multi-user detection (CS-MUD) is not limited to subsets M₁, M₂, . . . <N, and the principle may equally be used for M₁, M₂, . . . ≤N.

In one embodiment of the invention, the carriers of at least one of the subsets M₁, M2, . . . may be adjacent. FIG. 6 shows a sample use of the bandwidth B as compared to the prior art in regard to a time-frequency grid in a sample CDMA system.

Here, individual terminal devices UE₁; UE₂; . . . together utilize only a portion of the available bandwidth B in each case. For example, terminal device UE₁ could use the bandwidth fraction B₁ here according to a multi-carrier compressed sensing multi-user system MCSM₁, while another terminal device UE₂ uses the bandwidth fraction B₂ here corresponding to a multi-carrier compressed sensing multi-user system MCSM₂, etc. That is, the respective terminal devices UE₁; UE₂; . . . can make contact with the base station BSS in parallel at the time. For example, the terminal devices UE₁, UE₂ use the same subcarrier and thus the same bandwidth, i.e., the terminal devices UE₁, UE₂ use the same physical resource (time-frequency resource). Since both terminal devices UE₁, UE₂ are located in a system, bandwidth is saved on account of the multiple occupation of resources as compared to the prior art. This enables significant greater granularity together with less complexity and more effective bandwidth utilization.

A sample base station receiver BSS-RX for such a multi-carrier compressed sensing multi-user system is shown accordingly as an example in FIG. 7 for the receiving of the set N of carriers. This reception does not differ from conventional systems and may accordingly be organized according to a typical multi-carrier processing in the MT processing block and provide, e.g., a conversion of the data from the time domain to the frequency domain.

Connected downstream from this, the subset M₁, M₂, . . . of carriers of the set N of carriers can be processed by means of compressed sensing multi-user detection in the CS-MUD block.

The processing here is possible in any manner, i.e., one may provide a parallel processing of different transmission subsystems MCSM₁, MCSM₂, . . . corresponding to the terminal devices UE₁; UE₂; . . . or a serial processing, or mixed forms thereof.

What is important is that the processing in turn makes advantageous use of the attribute of the transmitter/transmitters TX, i.e., the terminal devices UE₁; UE₂; . . . , namely, that the signals are perceived as sparsely occupied.

The base station BSS can now detect a transmission of the terminal device UE₁; UE₂; . . . from the plurality of the received set N of carriers by means of compressed sensing multi-user detection (CS-MUD).

This uses the attribute of typical machine communication that a typical terminal device is usually only sporadically active, so that even in the case of a large number of terminal devices generally only a (small) fraction are sending data at any given time. This kind of sporadic use can also be understood as sparsely occupied multi-user signals at the base station BSS.

Quite generally, this may also be described with the following steps of the method. At first, a set N of carriers is received by the base station receiver BSS-RX. Then a transmission of one terminal device UE₁; UE₂; . . . from the plurality of the received set N of carriers is detected from at least one subset M₁, M₂, . . . of the set N of carriers by means of compressed sensing multi-user detection (CS-MUD).

The detection step can readily provide both an activity detection and a data estimation from a sparsely occupied multi-user signal. Advantageously, an activity detection (MUD) can be done at first, e.g., MCSM₃ is active, and then the compressed sensing (CS) is applied at least to the affected subset M₃ of carriers N.

Compressed sensing is a method of signal processing which enables a signal to be efficiently obtained and reconstructed by seeking solutions for an underdetermined linear system. One utilizes the fact that, by optimization with respect to sparse occupation (sparsity), it is enough to evaluate significantly fewer samples than would otherwise be expected by the Shannon-Nyquist sampling theorem.

Depending on the higher transmission protocol used (in the ISO/OSI model), successful reception can now be reported as shown in FIG. 3 by sending a confirmation ACK to the terminal device UE₁; UE₂; . . . , thus indicating that the sending was successful.

In a correspondingly designed terminal device, which is shown schematically in FIG. 5 in relation to the transmitter TX of the terminal device UE₁; UE₂; . . . , the following steps may be implemented accordingly.

First of all, at least one subset M₁, M₂, . . . of carriers of the set N of carriers is selected, where M₁, M₂<N. The selection can be determined in advance, for example by of a higher layer (in the ISO/OSI model), or be negotiated, and is not necessary for the further understanding of the invention.

After this, the data being sent by the terminal device can be modulated in a Mod block and apportioned among a plurality of (logical) carriers in a block spread and these can be distributed by means of a block map among the subset M₁, M₂, . . . of (physical) carriers of the set N of carriers. Of course, this is merely to be understood as an example and depending on the modulation scheme used it may be suitably implemented in one or more blocks.

The data so modulated and distributed may then be sent to the base station BSS.

Depending on the higher transmission protocol used (in the ISO/OSI model), the successful reception can now be reported as shown in FIG. 3 by the reception of an acknowledgement ACK from the base station BSS, thus indicating that the sending was successful.

Furthermore, it may be provided that prior to the sending, the terminal device UE₁, UE₂, . . . first attempts to detect activity on one or more carriers of the set N of carriers. This may be used, e.g., to assess the channel quality in the corresponding bandwidth B₁, B₂, . . . Bₖ, and/or to obtain the selection of a subset M₁, M₂, . . . or generally obtain the release for sending in the event of lack of activity on the corresponding bandwidth.

The invention may then be particularly advantageously used if the bandwidth of the subset M₁, M₂, . . . of carriers of the set N of carriers is less than or equal to the coherency bandwidth B_{c} of the (sub)channel.

The coherency bandwidth B_{c} (in Hertz) can be calculated by

$${B}_{c} \approx \frac{1}{{τ}_{max}}$$

Here, τₘₐₓ the time difference between the start and end of the channel pulse response. This is is also known as the delay spread.

The benefit of this is that, if the bandwidth is B₁, B₂, . . . Bₖ≤B_{c}, one only requires at most a very simple channel estimation within the bandwidth B₁, B₂, . . . Bₖ, which lowers the design and implementation expense. Furthermore, one may then use noncoherent modulation concepts, such as a differential modulation scheme, which in turn leads to less complexity, because for example no channel estimation is needed any longer. That is, when the condition in FIG. 6 B₁, B₂, . . . Bₖ≤B_{c} is fulfilled, each of the subsystems MCSM₁, MCSM₂, . . . uses only a small bandwidth of the overall channel, so that the dot-and-dash transmission function of the channel can be assumed to be (almost) constant within the respective bandwidth B₁, B₂, . . . Bₖ.

It should be noted that the system furthermore allows the subset M to vary, i.e., use of one subset M₁ during a first transmission and another subset M₂ . . . in a second subset. In this way, diversity can be achieved in terms of time.

As already described in the beginning, the invention can be applied to the most diverse wireless or wired systems. In particular, however, it is suitable for use in a wireless communication system, and especially for use in a UMTS, LTE, mobile radio system of the 5gh generation, WFi, or iDEN communication system. In general, the invention can find use in any multi-carrier scheme, and in particular orthogonal multi-carrier schemes in combination with CDMA, also known as MC/OFDM-CDMA, may serve as the basis.

For example, the invention can find application in a LTE system (or comparable systems) as follows. From the typically available N carriers for a normal bandwidth B, a subset M is formed. The modulated data is then mapped by means of a spread sequence onto M subcarriers. In a CDMA (code division multiple access) system, for example, the CDMA sequences in the frequency domain (at the transmitter side) are applied only to the subset M. The receiver side uses compressed sensing multi-user detection and thus utilizes the attribute that the signal appears to be sparsely occupied.

Furthermore, with the use of CS-MUD it is possible to provide both an activity detection and a derivation of the data sent. In this way, a secure data transmission is greatly facilitated.

By means of the invention, the attribute of typical machine-to-machine communication is utilized, namely, that the communication is rather sparsely occupied. In this way, dramatic bandwidth savings of more than 50% can be realized as compared to the prior art, the bandwidth gain being substantially a function of the number of subsets M₁, M₂, . . . of carriers used in relation to the overall number N of carriers.

Furthermore, the modulation scheme in fact used for these carriers may now be chosen as noncoherent, since the bandwidth of the subsets used can be chosen to be less than or equal to the coherency bandwidth B_{c}. In this way, the channel estimation can be dramatically simplified or eliminated.

Furthermore, if the bandwidth of the subsets used is chosen less than or equal to the coherency bandwidth B_{c}, the channel estimation may even be eliminated.

Furthermore, the bandwidth available by means of the invention is better utilized than in conventional systems, since a plurality of terminal devices UE₁; UE₂; . . . now form corresponding subsystems MCSM₁; MCSM₂; . . . along with a base station BSS and can thus better utilize the overall bandwidth B, since these may now communicate in parallel with the base station. In this way, it is also possible, for example in a CDMA system, to dynamically allocate the time-frequency grid.

Since the system according to the invention is also designed as a direct access system, as represented in FIG. 3, the control signaling overload decreases, so that an improved bandwidth utilization is made possible in this way as well.

What is claimed is:

1. A multi-carrier compressed sensing multi-user system,
wherein the system provides connections between a base station and a plurality of terminal devices, wherein several terminal devices access the same transmission medium at the same time,
wherein the system uses a multi-carrier modulation with a set N of carriers,
wherein a terminal device uses at least a subset M₁, M₂, . . . of carriers of the set N of carriers in each case,
where M₁,M₂<N, and wherein a first terminal device uses a first subset M₁ of carriers and a second terminal device uses a second subset M₂ of carriers, wherein at least one carrier of the first subset M₁ is also part of the second subset M₂,
wherein furthermore the base station detects a transmission of the first terminal device and a transmission of the second terminal device from the plurality of the received set N of carriers by means of compressed sensing multi-user detection.

2. The multi-carrier compressed sensing multi-user system as claimed in claim 1, wherein the carriers of at least one of the subsets are adjacent.

3. A base station receiver for the multi-carrier compressed sensing multi-user system as claimed in claim 1, wherein the base station receiver is set up to receive the set N of carriers, wherein the subset M₁, M₂, . . . of carriers of the set N of carriers is processed downstream by means of compressed sensing multi-user detection in order to detect a transmission of the first terminal device and a transmission of the second terminal device from the plurality of the received set N of carriers.

4. A method for a base station receiver as claimed in claim 3, comprising the steps:
reception of a set N of carriers,
wherein a transmission of a terminal device from the plurality of the received set N of carriers is then detected from at least one subset M₁, M₂, . . . of the set N of carriers by means of compressed sensing multi-user detection, wherein both an activity detection and a data estimation is undertaken from a sparsely occupied multi-user signal.

5. The method for a base station receiver as claimed in claim 4, further comprising the step of processing of the set N of carriers, wherein a signal present in the time domain is transferred to the frequency domain.

6. The method for a base station receiver as claimed in claim 4, further comprising the step sending a confirmation to the terminal device, that the send was successful.

7. A method for a terminal device in the system as claimed in claim 1, comprising the steps:
selection of at least one subset M₁, M₂, . . . of carriers of the set N of carriers used, where M₁,M₂<N,
modulation and distribution among the subset M₁, M₂, . . . of carriers of the set N of carriers of the terminal device data to be sent,
transmission of the modulated and distributed data to a base station.

8. The method for a terminal device as claimed in claim 7, further comprising the step of detection of activity on one or more carriers of the set N of carriers.

9. The method for a terminal device as claimed in claim 7, further comprising the step of waiting for a confirmation by the base station that the transmission was successful.

10. The method for a terminal device as claimed in claim 7, wherein the selection is done on the basis of a channel quality estimation with respect to a subset M₁, M₂, . . . of carriers of the set N of carriers.

11. The method for a terminal device as claimed in claim 7, wherein the bandwidth of the subset M₁, M₂, . . . of carriers of the set N of carriers is less than or equal to the coherency bandwidth of the channel.

12. The method as claimed in claim 11, wherein the subset M₁, M₂, . . . of carriers of the set N of carriers are modulated with a noncoherent differential modulation scheme.

13. The method as claimed in claim 5, wherein the method is used in a wireless communication system.

14. The method as claimed in claim 5, wherein the method is used in a UMTS, LTE, mobile radio system of the 5th generation, WiFi, or iDEN communication system.

15. The method as claimed in claim 5, wherein the number of carriers in the subsets M₁, M₂, . . . is equal.

16. The method as claimed in claim 5, wherein the terminal device provides machine communication.
